(19) United States
(12) Patent Application Publication
(10) Pub. No.: US 2010/0322093 A1
(43) Pub. Date: Dec. 23, 2010

(54) COMMUNICATION DEVICE, COMMUNICATION SYSTEM, AND PROCESSING METHOD BY COMMUNICATION DEVICE

(75) Inventors: Tatsuya Suzuki, Yokohama (JP); Toru Igarashi, Yokohama (JP); Koichi Suzuki, Yokohama (JP)

Correspondence Address: ARENT FOX LLP, 1050 CONNECTICUT AVENUE, N.W., SUITE 400, WASHINGTON, DC, 20036, US

(73) Assignee: FUJITSU SEMICONDUCTOR LIMITED, Shin-Yokohama (JP)

(21) Appl. No.: 12/792,550

(22) Filed: Jun. 2, 2010

(30) Foreign Application Priority Data
Jun. 18, 2009 (JP) 2009-145687

(51) Int. Cl. H04L 12/26

(52) U.S. Cl. 370/252

(57) ABSTRACT

A communication device, which receives data and checks a header in the data, includes: a first check circuit configured to detect whether or not a value in the header is within a first range; a second check circuit configured to detect whether or not a value of a data length field of the header is within a second range; and a third check circuit configured to detect whether or not a value of a connection identifier field of the header is within a third range.

### CROSS-REFERENCE TO RELATED APPLICATIONS

This application claims the benefit of priority from Japanese Patent Application No. 2009-145687 filed on Jun. 18, 2009, the entire contents of which are incorporated herein by reference.

### BACKGROUND

1. Field

The embodiments discussed herein relate to a communication device.

2. Description of Related Art

In a wireless communication system, user traffic information or a communication protocol message includes a plurality of packets. A packet may be a Protocol Data Unit (hereinafter referred to as “PDU”) specified by a Medium Access Control (hereinafter referred to as “MAC”) protocol. The PDU includes a MAC header portion indicating information such as the configuration format and the length of the PDU and a payload portion including data.

A burst includes one or more PDUs. A frame includes one or more bursts. A receiving stage distinguishes burst regions from the frame, and processes the PDUs transmitted thereto.

The related art is disclosed in, for example, Japanese Laid-open Patent Publication No. 2007-195185 and International Publication No. WO99/07100.

### SUMMARY

According to one aspect of the embodiments, a communication device, which receives and checks a header in the data, includes: a first check circuit configured to detect whether or not a value in the header is within a first range; a second check circuit configured to detect whether or not a value of a data length field of the header is within a second range; and a third check circuit configured to detect whether or not a value of a connection identifier field of the header is within a third range.

Additional advantages and novel features of the invention will be set forth in part in the description that follows, and in part will become more apparent to those skilled in the art upon examination of the following or upon learning by practice of the invention.

### BRIEF DESCRIPTION OF THE DRAWINGS

FIG. 1 illustrates an exemplary communication system;

FIG. 2 illustrates an exemplary format of a PDU;

FIG. 3 illustrates an exemplary communication device;

FIG. 4 illustrates an exemplary communication process;

FIG. 5 illustrates an exemplary process by a MAC header check circuit;

FIG. 6 illustrates an exemplary communication device; and

FIG. 7 illustrates an exemplary communication device.

### DESCRIPTION OF EMBODIMENTS

If an error is detected in a MAC header portion of a data packet, a payload portion of the data packet might not be processed.

In the burst process of a receiving stage of a wireless communication system, if there is an error in a PDU having a decoded MAC header, the PDU may be separated by a given process. Although an HCS (Header Check Sequence) is performed to check the error in the MAC header, the HCS may not detect the MAC header error. Therefore, the given process performed after the detection of the MAC header error may increase the process latency.

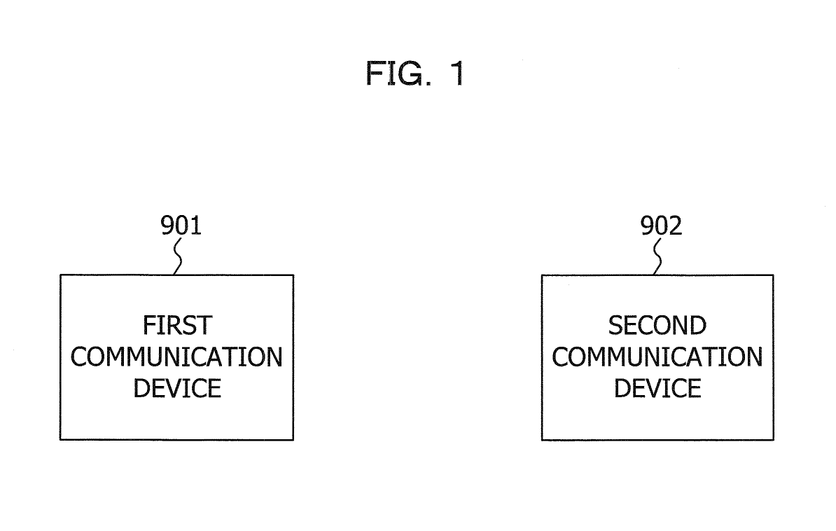

FIG. 1 illustrates an exemplary communication system. The communication system includes a first communication device 901 and a second communication device 902. The first communication device 901 wirelessly transmits, for example, one or more bursts 101. The second communication device 902 receives the one or more bursts 101 transmitted by the first communication device 901. Each of the bursts 101 includes one or more protocol data units, i.e., PDUs 100.

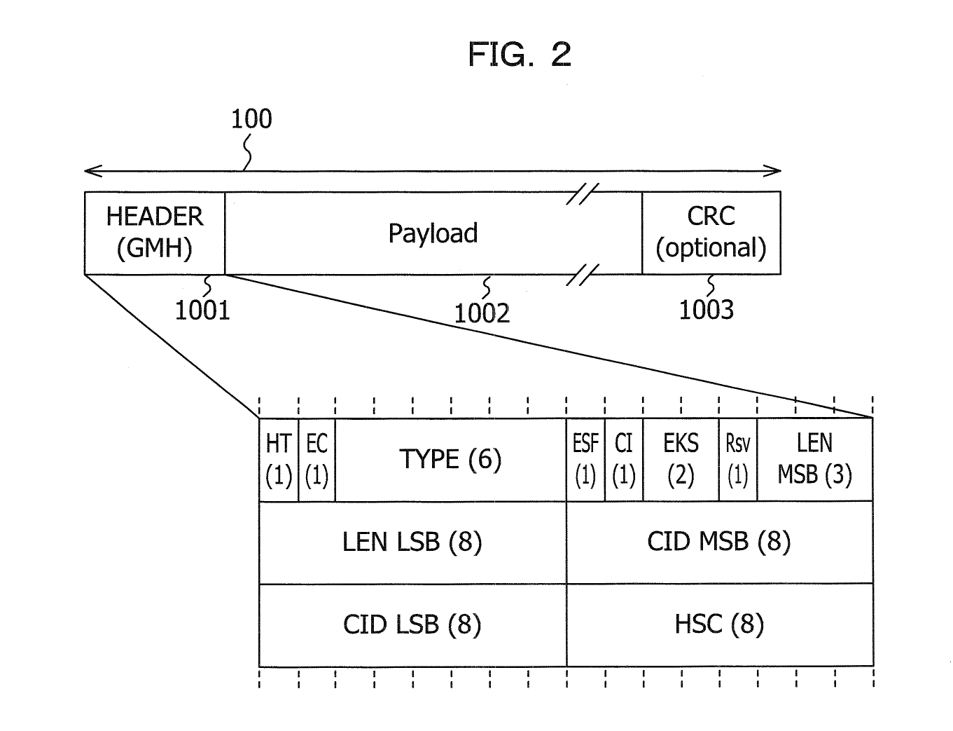

FIG. 2 illustrates an exemplary format of the PDU. In a wireless WiMAX (Worldwide Interoperability for Microwave Access) system, a maximum value of the length of the PDU 100 may be 2047 bytes. The PDU 100 includes a MAC header (GMH: Generic MAC Header) 1001, a payload 1002, and a CRC (Cyclic Redundancy Check) field 1003. The payload 1002 may be a data portion. The CRC field 1003 may include 32-bit error check data used to check whether or not there is an error in the entire PDU 100.

The MAC header 1001 has a length of 6 bytes, and includes a 1-bit HT (Header Type) field, a 1-bit EC (Encryption Control) field, a 6-bit TYPE field, a 1-bit ESF (Extended Subheader Field), a 1-bit CI (CRC Indicator) field, a 2-bit EKS (Encryption Key Sequence) field, a 1-bit Rsv (Reserved) field, a 1-bit PDU LEN (LENgth) field, an 8-bit CID (Connection Identifier) field, and an 8-bit HCS (Header Check Sequence) field.

The PDU LEN (LENgth) field indicates the length of the PDU 100. The HCS field may be an 8-bit CRC error check field used to check whether or not there is an error in the MAC header 1001.

The second communication device 902 receives one or more bursts 101, and checks the MAC header 1001 of the PDU 100.

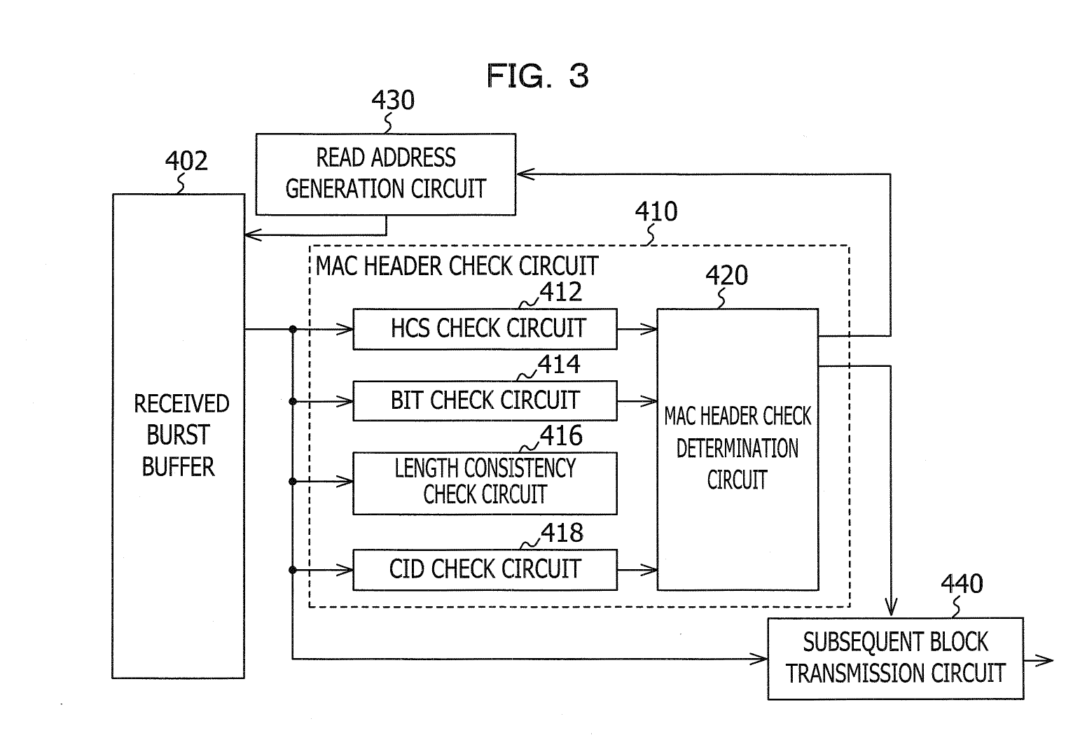

FIG. 3 illustrates an exemplary communication device. The second communication device 902 illustrated in FIG. 1 includes a received burst buffer 402 for storing the received bursts 101. The second communication device 902 reads 6 bytes corresponding to the MAC header 1001 of the first PDU 100 included in each of the stored bursts 101, and inputs the read bursts 101 to a MAC header check circuit 410. The MAC header check circuit 410 includes an HCS check circuit 412, a bit check circuit 414, a length consistency check circuit 416, a CID check circuit 418, and a MAC header check determination circuit 420.

The HCS check circuit 412 performs an error check based on the HCS field of the MAC header 1001. The bit check circuit 414 determines whether or not each of the bits in the MAC header 1001 has a given value. The length consistency check circuit 416 determines whether or not the value of the PDU LEN (LENgth) field of the MAC header 1001 is at least the minimum value and at most the maximum value. The CID check circuit 418 determines whether or not the CID field of the MAC header 1001 has a given value.

The MAC header check determination circuit 420 determines the acceptability of data, if the HCS check circuit 412, the bit check circuit 414, the length consistency check circuit 416 and the CID check circuit 418 determine the data is acceptable.

One of the HCS check circuit 412, the bit check circuit 414, the length consistency check circuit 416, and the CID check circuit 418 may be provided.

When inputting a signal indicating the acceptance of the data from the MAC header check determination circuit 420, a subsequent block transmission circuit 440 transmits, to a subsequent block, data corresponding to the length of the PDU 100 input from the received burst buffer 402. When inputting a signal indicating the acceptance of data from the MAC header check determination circuit 420, a read address generation circuit 430 adds an address corresponding to the length of the PDU 100, and outputs the read address for the next PDU 100 to the received burst buffer 402. In accordance with the read address, the received burst buffer 402 outputs the data of the next PDU 100 to the MAC header check circuit 410 and the subsequent block transmission circuit 440.

When a signal indicating the rejection of data is input from the MAC header check determination circuit 420, the subsequent block transmission circuit 440 stops the transmission of data to the subsequent block. When a signal indicating the rejection of data is input from the MAC header check determination circuit 420, the read address generation circuit 430 increments the address, and outputs the incremented address to the received burst buffer 402. The received burst buffer 402 outputs the data of the next address to the MAC header check circuit 410 and the subsequent block transmission circuit 440. The MAC header check circuit 410 checks the MAC header 1001 of the input data. The above-described process may be repeated until the acceptance of data is determined. The address of the accepted data may be determined to be the starting point of the MAC header 1001.

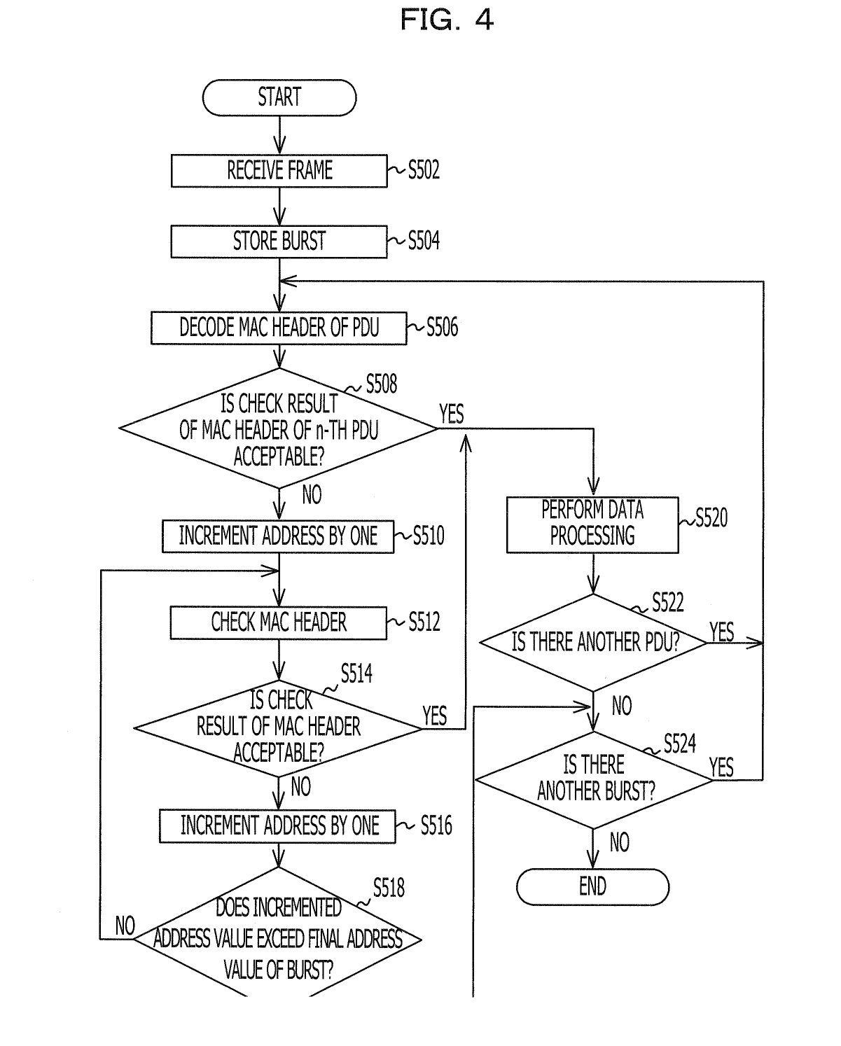

FIG. 4 illustrates an exemplary communication process. The communication process illustrated in FIG. 4 may be performed by the second communication device 902 illustrated in FIG. 1. In an operation S502, the second communication device 902 receives from the first communication device 901 a frame including a plurality of bursts 101. The process proceeds to an operation S504. In the operation S504, the second communication device 902 selects, from the plurality of bursts 101 of the received frame, the burst 101 corresponding to the second communication device 902 in accordance with the burst number, and stores the selected burst 101 in the received burst buffer 402. The process proceeds to an operation S506. In the operation S506, the second communication device 902 decodes the MAC header 1001 of the n-th PDU 100. The process proceeds to an operation S508. In the operation S508, the MAC header check circuit 410 performs an HCS check, a bit check, a length consistency check, and a CID check on the n-th PDU 100. If there is an error in the MAC header 1001, the process proceeds to an operation S510. If there is no error in the MAC header 1001, the process proceeds to an operation S520.

In the operation S510, to perform the error check at the next address, the read address generation circuit 430 increments by one the read address to be read by the received burst buffer 402. The processing proceeds to an operation S512. In the operation S512, the MAC header check circuit 410 checks the MAC header 1001 of the PDU 100 read from the received burst buffer 402, in a similar manner as in the operation S508. The processing proceeds to an operation S514. If there is no error in the MAC header 1001 of the read data corresponding to the incremented address, the incremented address may be determined to be the starting point of the MAC header 1001.

In the operation S514, the MAC header check circuit 410 checks the MAC header 1001 in a similar manner as in the operation S508. If there is an error in the MAC header 1001, the process proceeds to an operation S516. If there is no error in the MAC header 1001, the process proceeds to the operation S520 to perform data processing.

In the operation S516, the read address generation circuit 430 increments by one the read address to be read by the received burst buffer 402, in a similar manner as in the operation S510. The process proceeds to an operation S518. In the operation S518, the second communication device 902 determines whether or not the incremented address value exceeds the final address value of the burst 101. If the incremented address value exceeds the final address value of the burst 101, the burst 101 is processed as an unprocessable error, and the process proceeds to an operation S524. If the incremented address value does not exceed the final address value of the burst 101, the process proceeds to the operation S512. The second communication device 902 may recognize the length of the burst 101.

In operation S520, the second communication device 902 processes the data. Then, the process proceeds to operation S522. For example, in operation S520, when the acceptance signal is input from the MAC header check determination circuit 420, the subsequent block transmission circuit 440 transmits, to the subsequent block, the PDU 100, which includes the accepted MAC header 1001, from the received burst buffer 402. In the operation S522, the second communication device 902 determines whether or not there is another PDU 100. If there is another PDU 100, the process returns to the operation S506. If another PDU 100 is absent, the process proceeds to an operation S524. In the operation S524, the second communication device 902 determines whether or not there is another burst 101. If there is another burst 101, the process returns to the operation S506. If another burst 101 is absent, the process is completed.

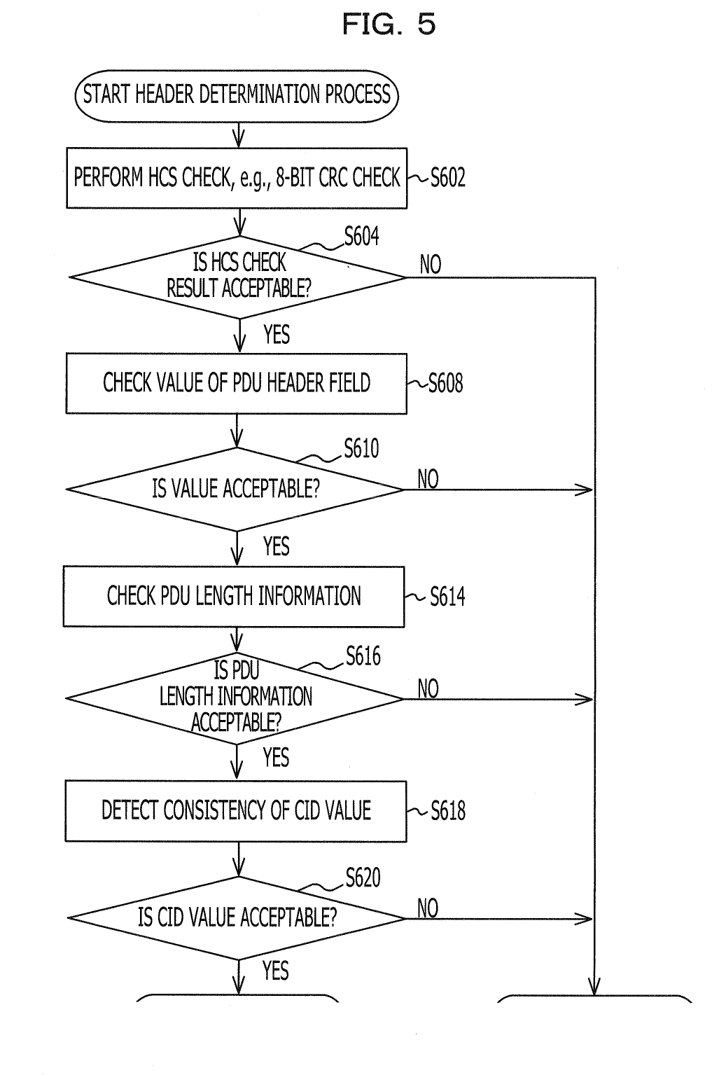

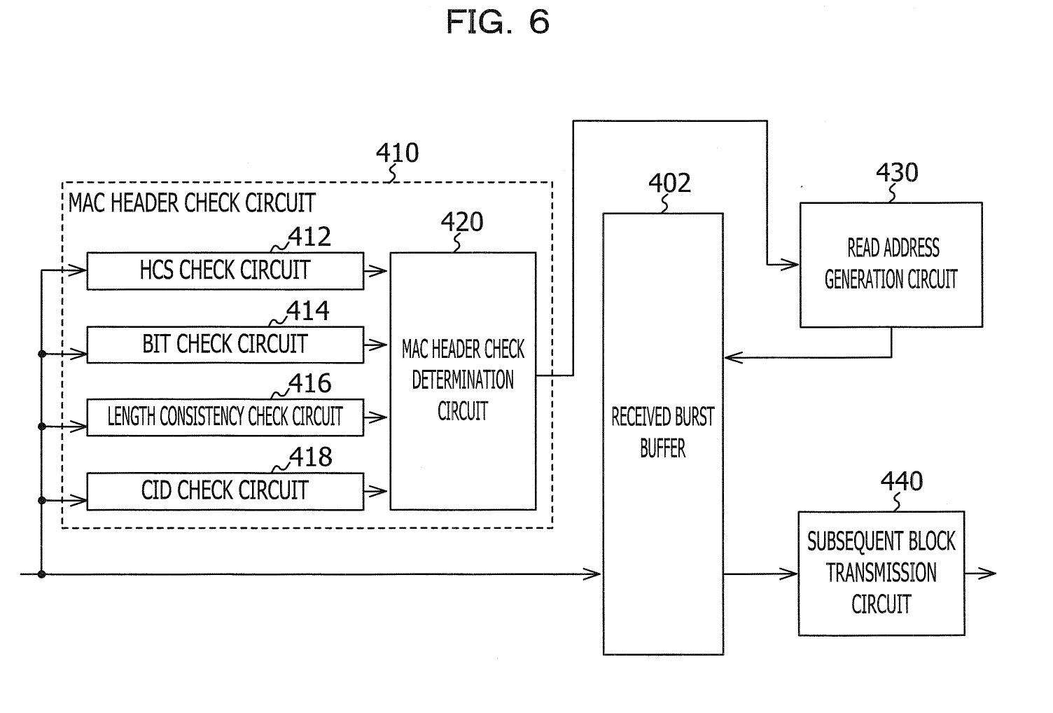

FIG. 5 illustrates an exemplary process by a MAC header check circuit. The MAC header check circuit illustrated in FIG. 6 may be the MAC header check circuit 410 illustrated in FIG. 3. The process illustrated in FIG. 5 may correspond to the operations S508, S512, and S514 illustrated in FIG. 4. In an operation S602, the HCS check circuit 412 performs the HCS check, e.g., an 8-bit CRC check, by using the HCS field illustrated in FIG. 2. The process proceeds to an operation S604. If the check result is accepted in the operation S604, the process proceeds to an operation S608. If the check result is rejected, the process is completed.

In the operation S608, the bit check circuit 414 checks the bits of the Rsv (Reserved) field in the MAC header 1001 illustrated in FIG. 2. The process proceeds to an operation S610. If the check result is accepted in the operation S610, the process proceeds to an operation S614. If the check result is rejected, the process is completed.

In the operation S614, with the use of the PDU LEN (LENgth) field, the length consistency check circuit 416 performs a length consistency check based on PDU configuration information, and checks whether or not the PDU length exceeds the burst length. The process proceeds to an operation S616. If there is no error in the operation S616, the process proceeds to an operation S618. If there is an error in the operation S616, the check is completed.

In the operation S618, the CID check circuit 418 checks the value of the CID field illustrated in FIG. 2. The process proceeds to an operation S620. If the check result is accepted in the operation S620, the process is completed with the check result determined acceptable. If the check result is rejected in the operation S620, the process is completed with the check result determined unacceptable.

The checks may be performed in any order, and may be performed concurrently.

In the operation S602, the HCS check circuit 412 performs the error check based on the HCS field of the MAC header 1001 illustrated in FIG. 2.

In the operation S608, it is determined whether or not each of the values in the MAC header 1001 is within a given range. The bit check circuit 414 detects that the Rsv (Reserved) field of the MAC header 1001 illustrated in FIG. 2 has a “0” bit, for example, and that the HT field of the MAC header 1001 illustrated in FIG. 2 has a “0” bit. The bit check circuit 414 detects which one of binary numbers 000000, 001010, 001100, 010000, 011010, and 011100 is included in the 6-bit TYPE field of the MAC header 1001 illustrated in FIG. 2.

In the operation S614, it is detected whether or not the value of the PDU LEN (LENgth) field of the MAC header 1001 illustrated in FIG. 2 is within a range between a minimum value and a maximum value. The length consistency check circuit 416 receives the burst 101 including the PDU 100, and detects that the value of the PDU LEN (LENgth) field of the MAC header 1001 illustrated in FIG. 2 is within a range between a length of the MAC header 1001 and a length of the remaining portion of the burst 101.

If the CI field illustrated in FIG. 2 has a value “1,” the CRC field 1003 having 4 bytes (32 bits) is added to the PDU 100. If the CI field has a value “0,” the CRC field 1003 having 4 bytes (32 bits) may not be added to the PDU 100.

If the EC field has a value “1,” a 4-byte PN (Packet Number) field and an 8-byte MAC field are added to the PDU 100. If the EC field has a value “0,” the 4-byte PN field and the 8-byte MAC field may not be added to the PDU 100.

If the ESF field has a value “1,” a 1-byte ESHLEN (Extended SubHeader group LENgth) field is added to the PDU 100. If the ESF field has a value “0,” the 1-byte ESHLEN field may not be added to the PDU 100. If the CI field has a value “0,” the EC field has a value “0,” and the ESF field has a value “0,” the MAC header 1001 may have 6 bytes. If the value of the PDU LEN (LENgth) field is less than 6 bytes, the MAC header 1001 may be rejected.

If the CI field has a value “1,” the EC field has a value “0,” and the ESF field has a value “0,” the MAC header 1001 may have 6 bytes, and the CRC field 1003 may have 4 bytes. If the value of the PDU LEN (LENgth) field is less than 10 (=6+4) bytes, the MAC header 1001 may be rejected.

If the CI field has a value “0,” the EC field has a value “1,” and the ESF field has a value “0,” the MAC header 1001 may have 6 bytes. The PN field may have 4 bytes. The MAC field may have 8 bytes. If the value of the PDU LEN (LENgth) field is less than 18 (=6+4+8) bytes, the MAC header 1001 may be rejected.

If the CI field has a value “1,” the EC field has a value “1,” and the ESF field has a value “0,” the MAC header 1001 may have 6 bytes. The PN field may have 4 bytes. The MAC field may have 8 bytes. The CRC field 1003 may have 4 bytes. If the value of the PDU LEN (LENgth) field is less than 22 (=6+4+8+4) bytes, the MAC header 1001 may be rejected.

If the CI field has a value “0,” the EC field has a value “0,” and the ESF field has a value “1,” the MAC header 1001 may have 6 bytes. The ESHLEN field may have 1 byte. If the value of the PDU LEN (LENgth) field is less than 7 (=6+1) bytes, the MAC header 1001 may be rejected.

If the CI field has a value “1,” the EC field has a value “0,” and the ESF field has a value “1,” the MAC header 1001 may have 6 bytes. The ESHLEN field may have 1 byte. The CRC field 1003 may have 4 bytes. If the value of the PDU LEN (LENgth) field is less than 11 (=6+1+4) bytes, the MAC header 1001 may be rejected.

If the CI field has a value “0,” the EC field has a value “1,” and the ESF field has a value “1,” the MAC header 1001 may have 6 bytes. The ESHLEN field may have 1 byte. The PN field may have 4 bytes. The MAC field may have 8 bytes. If the value of the PDU LEN (LENgth) field is less than 19 (=6+1+4+8) bytes, the MAC header 1001 may be rejected.

If the CI field has a value “1,” the EC field has a value “1,” and the ESF field has a value “1,” the MAC header 1001 may have 6 bytes. The ESHLEN field may have 1 byte. The PN field may have 4 bytes. The MAC field may have 8 bytes. The CRC field 1003 may have 4 bytes. If the value of the PDU LEN (LENgth) field is less than 23 (=6+1+4+8+4) bytes, the MAC header 1001 may be rejected.

In the operation S618, it is detected whether or not the value of the CID field of the MAC header 1001 illustrated in FIG. 2 is within a given range. For example, the CID check circuit 418 accepts the CID field having values indicating the CID, broadcast, and multicast for each connection.

When the check by the HCS check circuit 412 is performed in the operation S602, the probability of the MAC header 1001 not having an error may be 1/256=0.4%. If the check by the HCS check circuit 412 in the operation S602, the check by the bit check circuit 414 in the operation S608, and the check by the length consistency check circuit 416 in the operation S614 are performed, the probability of the MAC header 1001 not having an error may be 0.00691%. Further, if the check by the CID check circuit 418 in the operation S618 is also performed, the probability of the MAC header 1001 not having an error may be reduced.

One of the HCS check circuit 412, the bit check circuit 414, the length consistency check circuit 416, and the CID check circuit 418 may be provided.

The bit check circuit 414 may detect that the value of the Rsv (Reserved) field of the MAC header 1001 illustrated in FIG. 2 is “0,” for example, and may detect that the value of the HT field of the MAC header 1001 illustrated in FIG. 2 is “0,” for example.

In the wireless communication system, the error of the MAC header 1001 is detected. Due to the operations S510 to S518 illustrated in FIG. 4, if there is an error in the MAC header 1001 of the PDU 100, the starting point of the MAC header 1001 of the next PDU 100 is detected. Therefore, the PDU 100 may be efficiently processed.

FIG. 6 illustrates an exemplary communication device. The exemplary communication device illustrated in FIG. 6 may be the second communication device 902 illustrated in FIG. 1. The received burst 101 is stored in the received burst buffer 402 and input to the MAC header check circuit 410. The MAC header check circuit 410 includes the HCS check circuit 412, the bit check circuit 414, the length consistency check circuit 416, and the CID check circuit 418. The MAC header check determination circuit 420 determines the acceptance of the MAC header 1001 based on the results of the checks by the HCS check circuit 412, the bit check circuit 414, the length consistency check circuit 416, and the CID check circuit 418. If the MAC header 1001 is accepted, the MAC header check determination circuit 420 outputs the address information and the length information of the MAC header 1001 to the read address generation circuit 430. The read address generation circuit 430 increments the address by the length of the MAC header 1001 based on the address and the length received from the MAC header check determination circuit 420. The received burst buffer 402 outputs the read data corresponding to the read address received from the read address generation circuit 430. The subsequent block transmission circuit 440 sequentially transmits, to the subsequent block, the data read from the received burst buffer 402.

The received burst buffer 402 buffers the PDU 100 input to the MAC header check circuit 410. If the result of the check by the MAC header check circuit 410 indicates the acceptance, the PDU 100 with the MAC header 1001 stored in the received burst buffer 402 is read.

In the wireless communication system, if there is an error in the MAC header 1001 of the PDU 100, the PDU 100 may be efficiently processed, and the processing latency when an error occurs may be reduced.

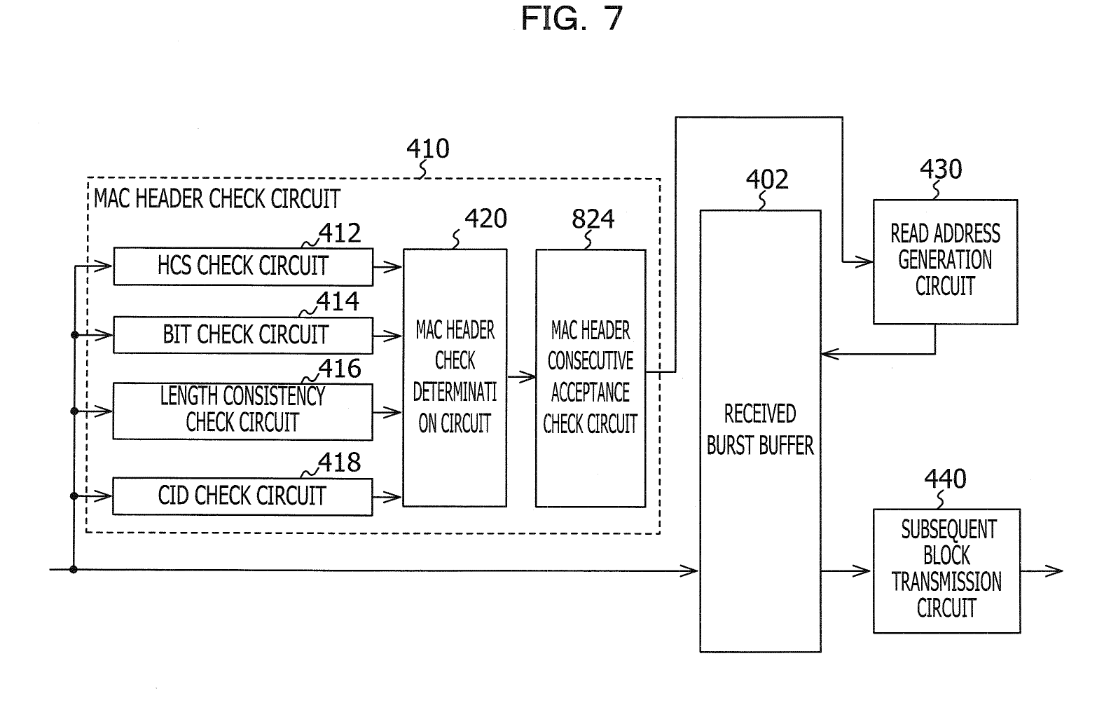

FIG. 7 illustrates an exemplary communication device. The exemplary communication device illustrated in FIG. 7 may be the second communication device 902 illustrated in FIG. 1. The communication device illustrated in FIG. 7 includes a MAC header consecutive acceptance check circuit 824 provided in the MAC header check circuit 410.

In the communication device, the burst 101 is stored in the received burst buffer 402 and input to the MAC header check circuit 410. The MAC header check circuit 410 includes the HCS check circuit 412, the bit check circuit 414, the length consistency check circuit 416, and the CID check circuit 418. The MAC header check determination circuit 420 notifies, for example, the MAC header consecutive acceptance check circuit 824 of the acceptance of data based on the checks by the HCS check circuit 412, the bit check circuit 414, the length consistency check circuit 416, and the CID check circuit 418. The MAC header consecutive acceptance check circuit 824 determines whether or not the position of the next MAC header 1001 indicated by the PDU LEN (LENgth) field of the MAC header 1001 is acceptable. If two or more MAC headers 1001 are consecutively accepted, the first MAC header 1001 is determined to be the finally accepted MAC header 1001. The MAC header consecutive acceptance check circuit 824 outputs to the read address generation circuit 430 the information of the top address and the length of the first MAC header 1001.

Based on the address and the length received from the MAC header consecutive acceptance check circuit 824, the read address generation circuit 430 increments the address by the length of the PDU LEN (LENgth) field of the MAC header 1001. The subsequent block transmission circuit 440 sequentially transmits, to the subsequent block, the data read from the received burst buffer 402.

If the burst 101 including a plurality of PDUs is input, and if the respective MAC headers 1001 of two or more of the PDUs 100 are consecutively accepted by the check, the MAC header 1001 of the first PDU 100 is determined acceptable.

The respective MAC headers 1001 of the plurality of PDUs are checked. The respective PDUs 100 corresponding to the two or more MAC headers 1001 consecutively determined acceptable by the check are transmitted to the subsequent block. Therefore, the probability of false error check of the MAC header 1001 may be reduced. Due to the operations S510 to S518 illustrated in FIG. 4, if there is an error in the MAC header 1001 of the PDU 100, the starting point of the MAC header 1001 of the next PDU is detected. Therefore, the PDU 100 may be processed efficiently.

Example embodiments of the present invention have now been described in accordance with the above advantages. It will be appreciated that these examples are merely illustrative of the invention. Many variations and modifications will be apparent to those skilled in the art.

1. A communication device which receives data and checks a header in the data, the communication device comprising:
a first check circuit configured to detect whether or not a value in the header is within a first range;
a second check circuit configured to detect whether or not a value of a data length field of the header is within a second range; and
a third check circuit configured to detect whether or not a value of a connection identifier field of the header is within a third range.

2. The communication device according to claim 1,
wherein the first check circuit, the second check circuit, and the third check circuit detect a field of the header including a bit set to a given value.

3. The communication device according to claim 1,
wherein the first check circuit detects whether or not one of a reserved field of the header and a header type field of the header includes a given value.

4. The communication device according to claim 3,
wherein the given value corresponding to the reserved field includes zero, and the given value corresponding to the header type field includes zero.

5. The communication device according to claim 1,
wherein the first check circuit detects whether or not a 6-bit type field of the header includes a given value.

6. The communication device according to claim 5,
wherein the given value includes at least one of binary numbers 000000, 001010, 010000, 011010, and 011100.

7. The communication device according to claim 1,
wherein the second check circuit receives a burst input including the data, and detects that the value of the data length field of the header is equal or more than a length of the header and equal or less than a length of the remaining portion of the burst input.

8. The communication device according to claim 1, further comprising:
a buffer configured to store the data; and
a read circuit configured to read the data from the buffer based on check results from at least one of the first check circuit, the second check circuit and the third check circuit.

9. The communication device according to claim 1,
wherein the first check circuit, the second check circuit, and the third check circuit receive a burst input including at least two or more consecutive data, and determine that there is no error in one of the at least two or more consecutive data, if there is no error in the header of the at least two or more consecutive data.

10. A communication system, comprising
a first communication device which receives data including a header from a second communication device and checks the headers,
wherein the first communication device includes:
a first check circuit configured to detect whether or not a value in the header is within a first range;
a second check circuit configured to detect whether or not a value of a data length field of the header is within a second range; and
a third check circuit configured to detect whether or not a value of a connection identifier field of the header is within a third range.

11. The communication system according to claim 10,
wherein the first check circuit detects whether or not one of a reserved field of the header and a header type field of the header includes a given value.

12. The communication system according to claim 10,
wherein the first check circuit detects whether or not a 6-bit type field of the header includes a given value.

13. The communication system according to claim 10, further comprising:
a buffer configured to store the data; and
a read circuit configured to read the data from the buffer based on the check results from at least one of the first check circuit, the second check circuit and the third check circuit.

14. The communication system according to claim 10,
wherein the first check circuit, the second check circuit, or the third check circuit receive a burst input including at least two or more consecutive data, and determine that there is no error in one of the at least two or more consecutive data, if there is no error in the headers of the at least two or more consecutive data.

15. A communication method comprising:
receiving a data including a header;
detecting whether or not a value in the header is within a first range;
detecting whether or not a value of a data length field of the header is within a second range;
detecting whether or not a value of a connection identifier field of the header is within a third range;
determining whether or not there is an error in the header based on result of at least one of detections; and
processing the data if there is no error in the header.
